(19) United States
(12) Patent Application Publication
(10) Pub. No.: US 2008/0255900 A1
(43) Pub. Date: Oct. 16, 2008

(54) PROCESS FOR IDENTIFYING POTENTIAL CUSTOMERS FOR BUSINESS OUTSOURCING

(76) Inventors: Richard Douglas Lawrence, Ridgefield, CT (US); Bonnie Kathryn Ray, South Nyack, NY (US); Heng Cao, Yorktown Heights, NY (US); Samer Takriti, Croton on Hudson, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/057,816

(22) Filed: Mar. 28, 2008

Related U.S. Application Data
(63) Continuation of application No. 10/758,530, filed on Jan. 16, 2004.

(51) Int. Cl. G06Q 99/00

(52) U.S. Cl. 705/7

(57) ABSTRACT

A process for determining which of a large number of candidate companies are most likely to outsource some aspect of their business operations, based on a mathematical model capable of analyzing a large number of inputs, including financial metrics, executive changes, and other significant corporate events like mergers and acquisitions.

### BACKGROUND OF THE INVENTION

1. Field of the Invention

The present invention generally relates to business outsourcing and, more particularly, to a process for assisting the identification of companies or organizations that might be preferentially inclined to outsource a component of their business.

2. Background Description

Organizations are increasingly outsourcing non-core components of their businesses. The reasons for outsourcing span the spectrum from the need to focus on core operations to the need to reduce cost and control expenses. When a component of the business is outsourced, it is transferred to a provider. We use information technology (IT) outsourcing as an example for clarifying the subject of our invention. However, it is important to realize that the technique presented here is general and can be applied to address outsourcing any component of a business.

Over the past twenty-five years, we have witnessed the evolution of computers from mainframes that required air conditioned buildings and specialized staff, to desktops and laptops that are easy to use and operate. Most businesses realized that in order to be efficient, their information must be captured and stored in electronic form, so that it can be accessed and searched when needed. As a result, industries, such as airlines, banks, and manufacturers to name a few, invested billions of dollars in building an information technology infrastructure. As a matter of fact, companies often used the sophistication of their IT infrastructures to distinguish themselves from their competitors. This trend became even more pronounced with the introduction of the Internet. Through the Internet, businesses found a low-cost vehicle that can reach every potential customer, regardless of his/her geographic location.

Today, the IT spending of any company, large or small, consumes a sizable amount of its budget. Furthermore, today's competitive market place requires each company to be efficient in it's spending, particularly when it comes to IT, where the latest technology could be obsolete in six to twelve months. As a result, many companies opt to outsource their IT operations to firms that specialize in operating IT efficiently and reliably.

The negotiations of an outsourcing deal are complex and lengthy. For an outsourcing provider, the negotiation phase often costs millions of dollars and requires an army of technical and legal experts. As a result, an outsourcing provider is often interested in ranking potential new customers and targeting those that are more likely to outsource.

Conversely, if there are several potential opportunities and if the provider has limited resources, then the provider needs to rank these opportunities so that the probability of success is maximized. This invention is a process that can be used by the provider to rank its potential customers in the order of their likelihood or propensity to outsource.

It is generally held that companies most likely to consider outsourcing are those that are experiencing poor financial performance, or that have had recent changes in executive management or other significant events such as a merger or acquisition. Prior approaches to the customer-targeting problem have been largely empirical in the following sense. A relatively small set of metrics summarizing the overall financial conditions of each company are obtained, each metric is multiplied by an empirically-determined “weight factor”, and a “propensity score” is then computed simply as the sum of these weighted features. A key deficiency in this approach is that no rigorous attempt is made to choose the weight factors such that the resulting scores are verifiably higher for companies that did actually outsource. Hence, if the selected features or their specified weights are incorrect, the resulting scores will be of little utility in predicting which companies are likely to outsource.

### SUMMARY OF THE INVENTION

It is therefore an object of the present invention to provide a process or methodology for ranking a large number (“universe”) of potential outsourcing customers for the purpose of identifying companies that appear to have an increased likelihood or propensity to outsource some aspect of their business operations.

According to the invention, we do the following:
1. We construct a set of historical “positive examples” of companies that have signed an outsourcing contract on a specific date within the recent past.
2. We construct a set of historical “negative examples” of companies that were clearly not interested in outsourcing on a specific date within the recent past.
3. For each positive and negative example, we construct a set of financial and news-based metrics or “features” characterizing each example during a time window created immediately preceding the associated date.
4. We build a statistical model designed to predict the probability of any example (characterized its feature set) belonging to the class of positive examples. This model is optimized to produce the best prediction against the set of aforementioned positive and negative examples.
5. We extract exactly the same set of features for the “universe” of companies that we wish to rank as potential outsourcing customers. These features are extracted during the time window preceding the date (usually the current date) for which the ranking or score is sought.

6. We apply the predictive model to the extracted features for each company in the “universe”, computing the probability that this company belongs to the class of positive examples. The computed probability is used as a score indicating the company's propensity to outsource, and sorting these scores yields the desired ordered list of companies to be targeted.

The user of the proposed process may be (a) a decision maker within an organization that is interested in marketing its outsourcing services to potential customers; (b) an intermediary who brokers outsourcing deals between customers and providers; or (c) a market intelligence agency that is interested in comparing and valuing companies as they relate to outsourcing propensity. In the case of our example of IT outsourcing, (a) outsourcing providers include such companies as Accenture, Computer Sciences Corp. (CSC), Electronic Data Systems (EDS), and Hewlett-Packard (HP); (b) intermediaries include companies such as TPI; and (c) market intelligence agencies include Gartner Group, Metagroup, and Forrester.

In the process according to the invention, outsourcing can include managing or owning some or all of the operations related to the outsourced processes. The operations may include business functions, IT services, computer support, call centers, accounting, human resources, procurement, transaction processing, and customer-relationship management. The operations may also include manufacturing, procurement, marketing, sales, distribution, transportation, and pricing.

Outsourcing by an entity or company can include management or ownership of some or all of the assets related to the outsourced processes. These assets may include computers, servers, computer storage devices, data centers, network infrastructure, network routers, web servers, and staff. Alternatively or in addition, the assets may include machines, assembly lines, trucks, vehicles, airplanes, and freights.

As used in the invention, positive pre-existing outsourcing instances may include some or all entities that outsourced operations in the past. Negative pre-existing outsourcing instances can be based on the pre-existing positive instances. Alternatively or in addition, negative pre-existing outsourcing instances can be dictated by business experts and/or captured from public information.

As used in the invention, the extracted features include financial information, such as stock price and credit rating. Other extracted financial information may include cash flow, gross profit margin, return on assets, expenses, revenue, receivables turnover, credit rating, earning per share, return on equity, inventory turnover, diversification, spending, public and government filings, management, press releases, mergers and acquisitions, accounting discrepancies, layoffs, earning announcements, and labor disputes.

As used in the invention, the score generated is a numerical value which represents the likelihood to outsource and the uncertainty of this likelihood. This score is a discrete value representing the likelihood to outsource and the uncertainty of this likelihood.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow diagram showing the overall methodology employed in the invention;

FIG. 2 is a flow diagram showing the process of identifying examples to be used as input to the mathematical model;

FIG. 3 is a flow diagram showing the process of feature extraction for each example;

FIG. 4 is a graph illustrating the time windows used in extracting the features for a positive example;

FIG. 5 is a graph illustrating the time windows used in extracting the features for a negative example;

FIG. 6 is a graph illustrating the time windows used in extracting the features for a candidate example;

FIG. 7 is a table listing the features, including both financial metrics and executive changes, extracted for each company; and

FIG. 8 is a flow diagram showing the process of building the predictive mathematical model.

### DETAILED DESCRIPTION OF A PREFERRED EMBODIMENT OF THE INVENTION

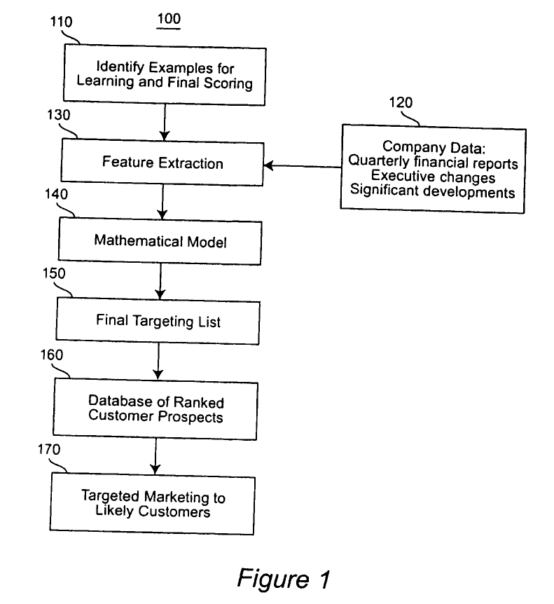

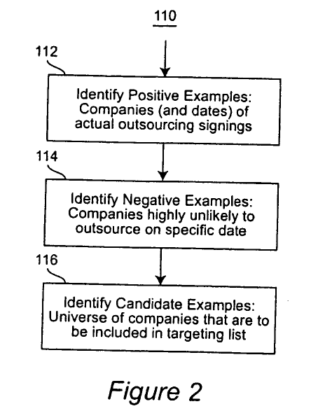

Referring now to the drawings, and more particularly to FIG. 1, there is shown a preferred embodiment of the process to identify potential customers for business outsourcing. Process 100 includes function block 110 which involves the identification of examples that are used to train the mathematical model, as well as the examples that are to be scored or evaluated as part of the output of the overall process. An “example” is uniquely defined by the identity of a company, plus the date on which information for this example is valid. FIG. 2 illustrates this process further.

Function block 112 involves the identification of actual historical examples of companies that have signed outsourcing contracts with any provider of such services. These examples are obtained from publicly available news filings describing outsourcing deals involving large total contract amounts using, for example, data mining techniques. The name of the company that signed the contract, and the date of the signing, uniquely defines a “positive” example.

Function block 114 involves identification of a set of companies and corresponding dates at which it is believed that these companies are highly unlikely to sign an outsourcing agreement. The name of the company unlikely to outsource, and the date of this predisposition, uniquely defines a “negative” example. Negative examples can be chosen in several ways, including the following:
i. Specification of such companies by knowledgeable experts in the field
ii. Specification of such companies that meet some pre-defined set of financial conditions
iii. Using the same companies as identified in the set of positive examples, but taking the “negative examples” at times well ahead of the time when the outsourcing deal was actually signed.
   The preferred embodiment uses option iii. The positive and negative examples are used to train the mathematical model.

Function block 116 involves identification of a set of companies that are considered to be potential candidates for outsourcing. There can be thousands of potential customers represented as “candidate” examples. The objective of the overall process is to predict the likelihood or propensity that each of these candidate companies will enter into an outsourcing contract at the current date. Ranking these companies yields the Targeting List output by function block 160 in FIG. 1.

Returning to FIG. 1, function block 120 represents the publicly available information on each of the companies represented by examples included in process blocks 112, 114, and 116 of FIG. 2. This information includes quarterly SEC filings, executive management changes, and other significant developments such corporate mergers and acquisitions. This data is acquired from various data providers, and imported into a single database holding all such data for all companies included in blocks 112, 114, and 116.

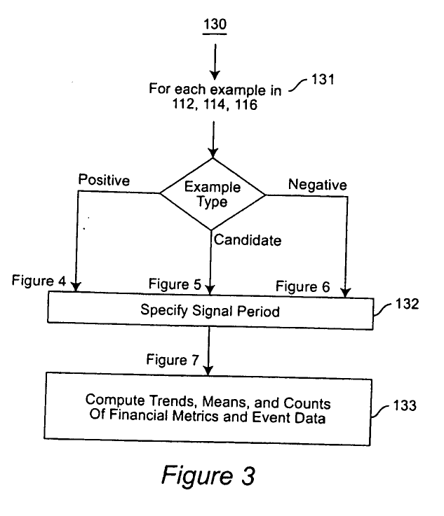

Function block 130 represents the process of reducing the information defined in function block 120 to obtain a set of metrics or explanatory “features” which can be used as input to a mathematical model (function block 140) designed to predict the propensity for outsourcing of each company. The specifics of this process are described in FIG. 3.

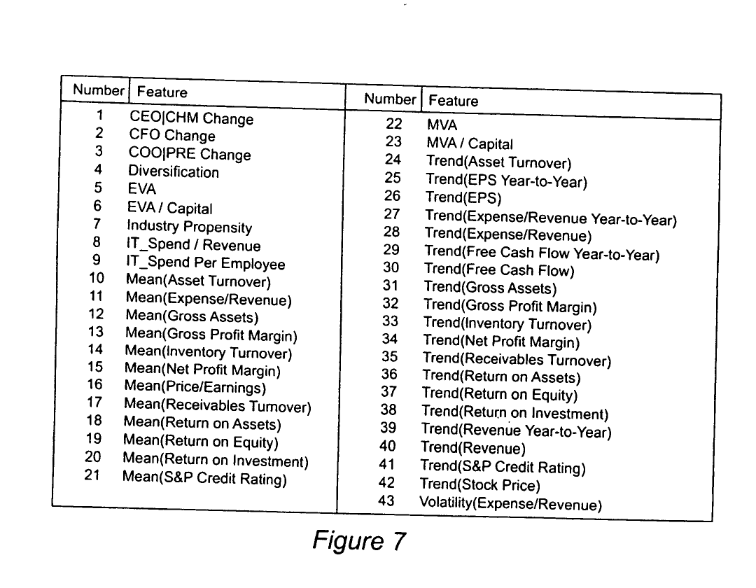

Each example is processed using different logic based on the type of example as determined in decision block 131. The objective of this process is to identify a “signal” period in function block 132 preceding the date associated with the example. The signal period refers to the time over which the features will be defined. This period is chosen to provide the most information about the expected likelihood of this company signing an outsourcing contract at the date associated with the example. Based on the selection of the signal period, the trends, means, and counts of financial metrics and event data are computed in function block 133, as described in more detail with reference to FIG. 7.

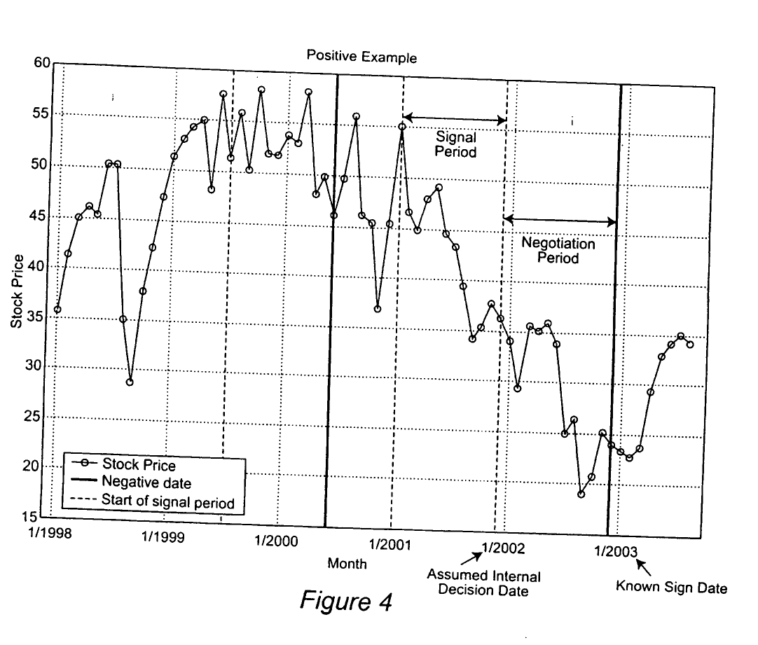

FIG. 4 illustrates the signal period for a “positive” example. A significant outsourcing contract can take a significant period of time (e.g., a year) to negotiate. The company signing such a contract presumably made the decision to outsource at some earlier time, and it is therefore necessary consider the various financial and news-based factors that preceded this internal decision. For this reason, the signal period for a positive example is specified some period of time before the announced public signing. FIG. 4 illustrates one such choice, assuming that the negotiation period was one year long.

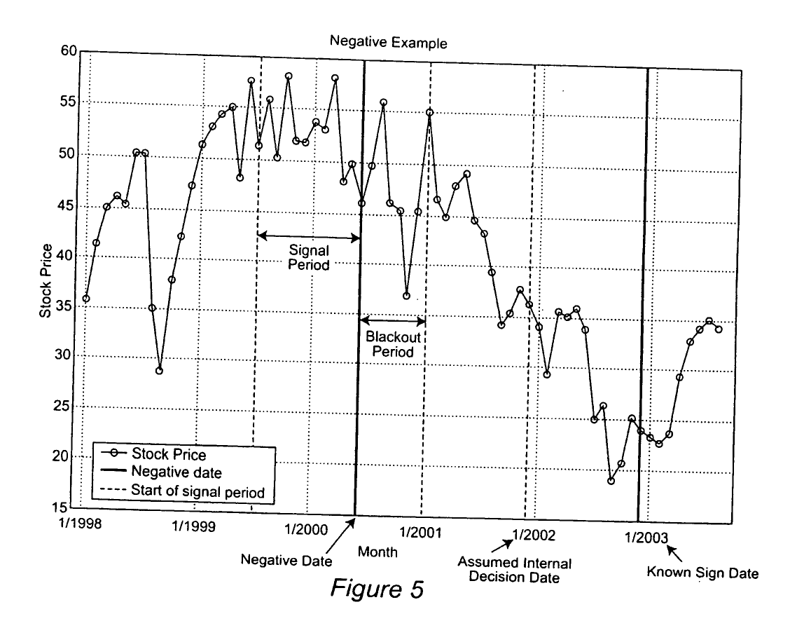

FIG. 5 illustrates the signal period for a “negative” example. Note that a negative example is drawn for the same company as a positive example, but taken earlier in time. A “blackout period” is introduced to insure that the signal period for the negative example exhibits no influence from the subsequent positive example.

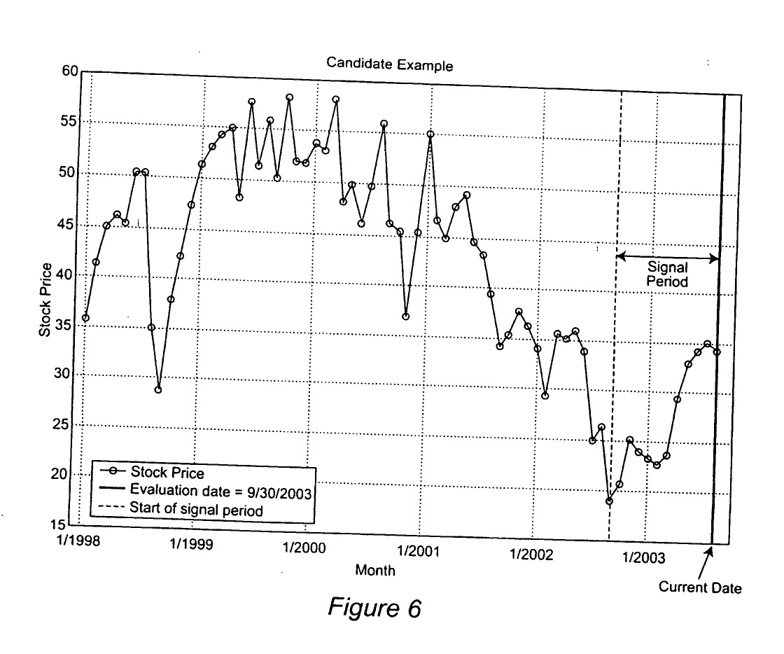

FIG. 6 illustrates the signal period for a “candidate” example. Here, the objective is to predict the outsourcing probability at the current date, so the signal period is defined immediately prior to the current date.

FIG. 7 lists examples of the financial and news features extracted in function block 133 of FIG. 3 according to the preferred embodiment of the invention. The mean refers to the average of the features (e.g., monthly close of the stock price, quarterly earnings per share) during the signal period. The trend refers to the normalized slope of the respective feature. These features are computed for all examples (positive, negative, and candidate), and saved for input to the predictive mathematical model.

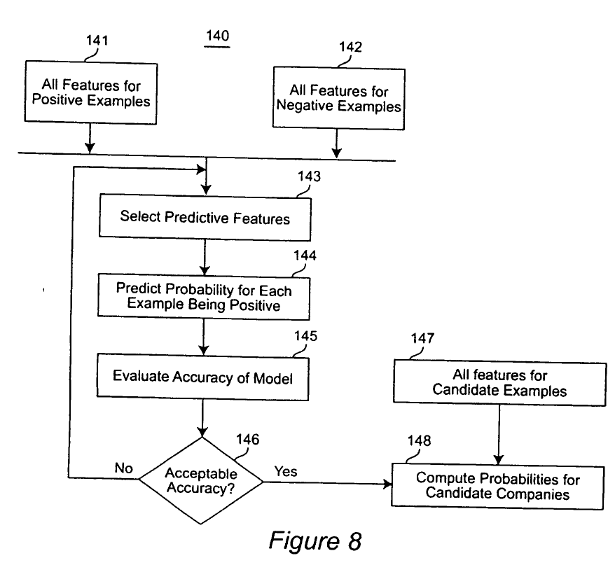

Returning again to FIG. 1, function block 140 represents the process of constructing a mathematical model that takes as inputs the features created in function block 130. The output of the model is a prediction of the probability that each input example belongs to the class of positive examples. This probability is, in turn, proportional to the probability that the company will sign an outsourcing contract. FIG. 8 illustrates the preferred embodiment for the modeling process 140.

Referring now to FIG. 8, the process accepts as input the features for each positive example 141 and each negative example 142. All features listed in FIG. 7 are initially presented to the model. Function block 143 selects a subset of these features that are mathematically most likely to differentiate positive and negative examples. Function block 144 constructs a model that uses the selected features 143 to predict the probability that any example will belong to the class of positive examples. Any appropriate predictive model can be used; in the preferred embodiment, we use a logistic regression model that admits as inputs both linear and higher-order cross terms of the selected features. Function block 145 evaluates the accuracy of the model by comparing the predicted probabilities (of belonging to the positive class) with the known labels (either positive or negative). The better this agreement, the more accurate the model. In decision block 146, a determination is made as to whether the evaluated accuracy is acceptable. If not, the set of processes in function blocks 143 to 145 is repeated until the most accurate model is obtained. The most accurate model is applied in function block 148 to all features extracted for the candidate examples 147. The output is the probability of outsourcing for each of the candidate examples (companies).

Returning again to FIG. 1, function block 150 forms the final targeting list by sorting the candidate probabilities computed as the output of block 140 so that the companies with the highest probability of outsourcing are at the top of the list. Function block 160 consists of constructing a database of the sorted candidate companies to facilitate marketing to the most promising outsourcing candidates by sales professionals in function block 170.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A process for identifying companies likely to outsource their information technology processes, comprising the steps of:
identifying positive and negative examples of such companies;
extracting features for these companies based on analysis of publicly available information, changes in executive management, and information including mergers and acquisitions; and
based on mathematical model, predicting a probability that a company will outsource, using the extracted features as inputs.

2. The process of claim 1, further comprising the step of identifying companies likely to outsource other business functions such as accounting, human resources, procurement, and customer relationship management.

3. A process for identifying entities likely to outsource processes, comprising the steps of:
identifying positive and negative pre-existing outsourcing instances for such entities;
extracting features for these entities based on available information; and
providing a score reflecting a likelihood that an entity will outsource, using the extracted features as inputs.

4. The process of claim 3, wherein an entity is a company.

5. The process of claim 4, wherein the company is a publicly traded company.

6. The process of claim 3, wherein outsourcing includes managing or owning some or all of the operations related to the outsourced processes.

7. The process of claim 6, wherein operations include business functions, information technology (IT) services, computer support, call centers, accounting, human resources, procurement, transaction processing, and customer-relationship management.

8. The process of claim 6, wherein operations include manufacturing, procurement, marketing, sales, distribution, transportation, and pricing.

9. The process of claim 3, wherein outsourcing includes managing or owning some or all of the assets related to the outsourced processes.

10. The process of claim 9, wherein assets include computers, servers, computer storage devices, data centers, network infrastructure, network routers, web servers, and staff.

11. The process of claim 9, wherein assets include machines, assembly lines, trucks, vehicles, airplanes, and freights.

12. The process of claim 3, wherein positive pre-existing outsourcing instances include some or all entities that outsourced operations in the past.

13. The process of claim 3, wherein negative pre-existing outsourcing instances are based on the pre-existing positive instances.

14. The process of claim 3, wherein negative pre-existing outsourcing instances are dictated by business experts.

15. The process of claim 3, wherein negative pre-existing outsourcing instances are captured from public information.

16. The process of claim 3, wherein the extracted features include financial information.

17. The process of claim 16, wherein financial information includes stock price and credit rating.

18. The process of claim 3, wherein the extracted features include financial information, stock price, cash flow, gross profit margin, return on assets, expenses, revenue, receivables turnover, credit rating, earning per share, return on equity, inventory turnover, diversification, spending, public and government filings, management, press releases, mergers and acquisitions, accounting discrepancies, layoffs, earning announcements, and labor disputes.

19. The process of claim 3, wherein the score is a numerical value.

20. The process of claim 19, wherein the score is represented by the likelihood to outsource and the uncertainty of this likelihood.

21. The process of claim 19, wherein the score is a discrete value representing the likelihood to outsource and the uncertainty of this likelihood.

22. A process for identifying entities likely to outsource their information technology, comprising the steps of:
identifying positive and negative pre-existing outsourcing instances of such entities;
extracting features for these companies based on publicly available information, including financial information, management structure and changes, and mergers and acquisitions; and
predicting a score that a company will outsource, using the extracted features as inputs.

23. The process of claim 22, wherein outsourcing includes managing or owning some or all of the operations related to the outsourced processes

24. The process of claim 22, wherein operations include business functions, information technology (IT) services, computer support, call centers, accounting, human resources, procurement, transaction processing, and customer-relationship management.

25. The process of claim 22, wherein outsourcing includes managing or owning some or all of the assets related to the outsourced processes.

26. The process of claim 25, wherein assets include computers, servers, computer storage devices, data centers, network infrastructure, network routers, web servers, and staff.

27. The process of claim 22 where the score is the probability of outsourcing and a confidence interval associated with that probability.

28. A process for identifying companies likely to outsource services comprising the steps of:
constructing a set of historical “positive examples” of companies that have signed outsourcing contracts with any provider for such services;
constructing a set of historical “negative examples” of companies that were clearly not interested in outsourcing on a specific date within the recent past;
for each positive and negative example, constructing a set of financial and news-based metrics or “features” characterizing each example during a time window created immediately preceding an associated date;
building a statistical predictive model designed to predict a probability of any example, characterized by its feature set, belonging to the class of positive examples, this model being optimized to produce a best prediction against the set of positive and negative examples;
extracting exactly the same set of features for a “universe” of companies that it is desired to rank as potential outsourcing customers, these features being extracted during a time window preceding a date for which the ranking or score is sought;
applying the predictive model to the extracted features for each company in the “universe” of companies;
computing a probability that a company belongs to the class of positive examples, the computed probability being used as a score indicating a company's propensity to outsource; and
sorting the scores to yield a desired ordered list of companies to be targeted.
